(19) United States
(12) Patent Application Publication
(10) Pub. No.: US 2007/0039475 A1
(43) Pub. Date: Feb. 22, 2007

(54) Device for defoaming oil in the lubricant circuit of an internal combustion engine

(75) Inventors: Claus-Dieter Unfried, Markgroningen (DE); Ulrich Huelsemann, Neuhausen (DE); Thomas Laudenbach, Pleidelsheim (DE)

Correspondence Address: CROWELL & MORING LLP;INTELLECTUAL PROPERTY GROUP, P.O. BOX 14300, WASHINGTON, DC, 20044-4300, US

(73) Assignee: DR. Ing. H.c.F. Posche, Weissach (DE)

(21) Appl. No.: 10/547,282

(22) PCT Filed: Feb. 19, 2004
(86) PCT No.: PCT/EP04/01591

§ 371 Date: Aug. 22, 2006

(30) Foreign Application Priority Data
Feb. 28, 2003 (DE) 103 08 761.3

(51) Int. Cl. B01D 19/00

(52) U.S. Cl. 96/219

(57) ABSTRACT

A device for defoaming and/or deaeration of oil in the lubricant system of an internal combustion engine in which the lubricant oil flowing back into an oil pan is conveyable by an oil suction pump into a separate oil tank. The device has an oil separator, preferably mounted on the oil tank. The oil separator has a deaeration space (10) which accommodates a wire mesh body (20).

### BACKGROUND OF THE INVENTION

This invention relates to a device for defoaming of oil in the lubricant system of an internal combustion engine and, more particularly, to a device in an engine in which the lubricant oil flowing back into an oil pan is conveyable by an oil suction pump into a separate oil tank, and having an oil separator preferably mounted on the oil tank, characterized in that the oil separator (6) has a deaeration space (10) in which a wire mesh body (20) is accommodated.

It is known (see, for example, DE 74 43 014 Z1) that the oil lubricant which is conveyed into a separate oil tank can be defoamed and/or deaerated through appropriate oil separation equipment in the case of an internal combustion engine with dry sump lubrication.

An object of this invention is to improve the efficiency of such oil separation devices so that there remains only a low residual gas content in the oil lubricant. Thus a secure and reliable oil lubricant supply to the corresponding consumers can be ensured, especially in sports cars, where high transverse and longitudinal accelerations occur.

This object has been achieved by providing that such a device includes an oil separator with a deaeration space in which a wire mesh body is accommodated.

The wire mesh body provided in the oil separator ensures effective and intense separation of the oil-laden gases so that the oil constituents captured by the wire mesh body are returned to the oil tank while the gases from which the oil has been removed can be supplied back to the intake system of the internal combustion engine in a closed circuit.

To achieve the largest possible surface area for the wire mesh body without increasing the outside dimensions of the oil separator, the wire mesh body can be configured as a funnel shape, i.e., a conical shape. In addition, this geometry of the wire mesh body also ensures a particularly effective separation of oil when the oil-laden gases flow through the oil separator.

To ensure a targeted flow of oil-laden gases through the wire mesh body, the latter is accommodated in a deaeration pipe which is provided with openings on at least its two ends.

The partial deaeration space provided above the wire mesh body, i.e., the deaeration pipe, is advantageously connected to a vacuum source, e.g., the intake manifold of the internal combustion engine.

Another advantageous aspect of this invention relates to the housing of the oil separator being configured so that it is possible to fill the oil tank with oil lubricant through this structural unit at the same time. To do so, a ring channel is provided coaxially with the deaeration space and is connected to an oil filling connection. Any additional oil filling connections which would normally be connected to the actual oil pan of the internal combustion engine via appropriate line sections can thus be eliminated.

The oil tank can be also integrated into the transmission case. Since the oil tank is mounted at the upper end of the transmission case, oil lubricant can be resupplied through the oil filling connection with no problem.

### BRIEF DESCRIPTION OF THE DRAWINGS

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

FIG. 1 is a perspective view showing a transmission case having an oil tank and an oil separation device,

FIG. 2 is a perspective view showing the oil separation device in a perspective view,

FIG. 3 is a longitudinal cross-section through the oil separation device of FIG. 2,

FIG. 4 is a section view along line III-III in FIG. 3,

FIG. 5 is a view along direction X in FIG. 3,

FIG. 6 is a section view along line V-V in FIG. 5 and

FIG. 7 is a view of the oil separation device of FIG. 2 from below.

### DETAILED DESCRIPTION OF THE DRAWINGS

In a transmission case 2, an oil-collecting space configured in one piece with the transmission case 2 and referred to below as the oil tank 4, is provided above the space for the differential. The oil-collecting space 4 is provided to accommodate the oil supply required for the dry sump circulating lubrication. The oil tank 4 has at its upper end a central opening on which an oil separator 6 is placed and mounted. The configuration of the oil separator 6 is explained in greater detail below.

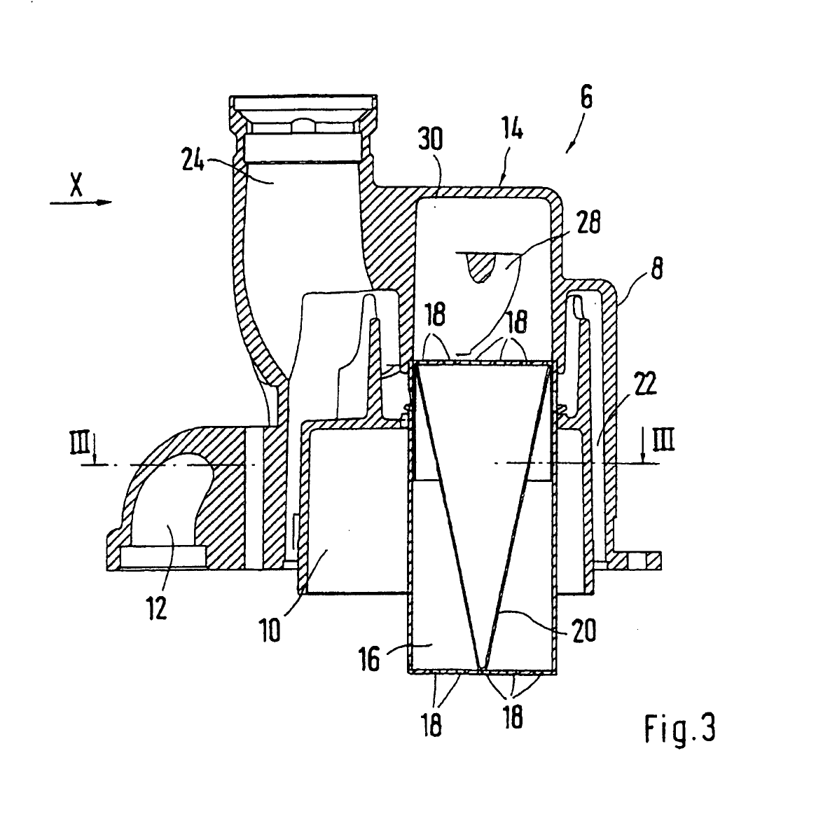

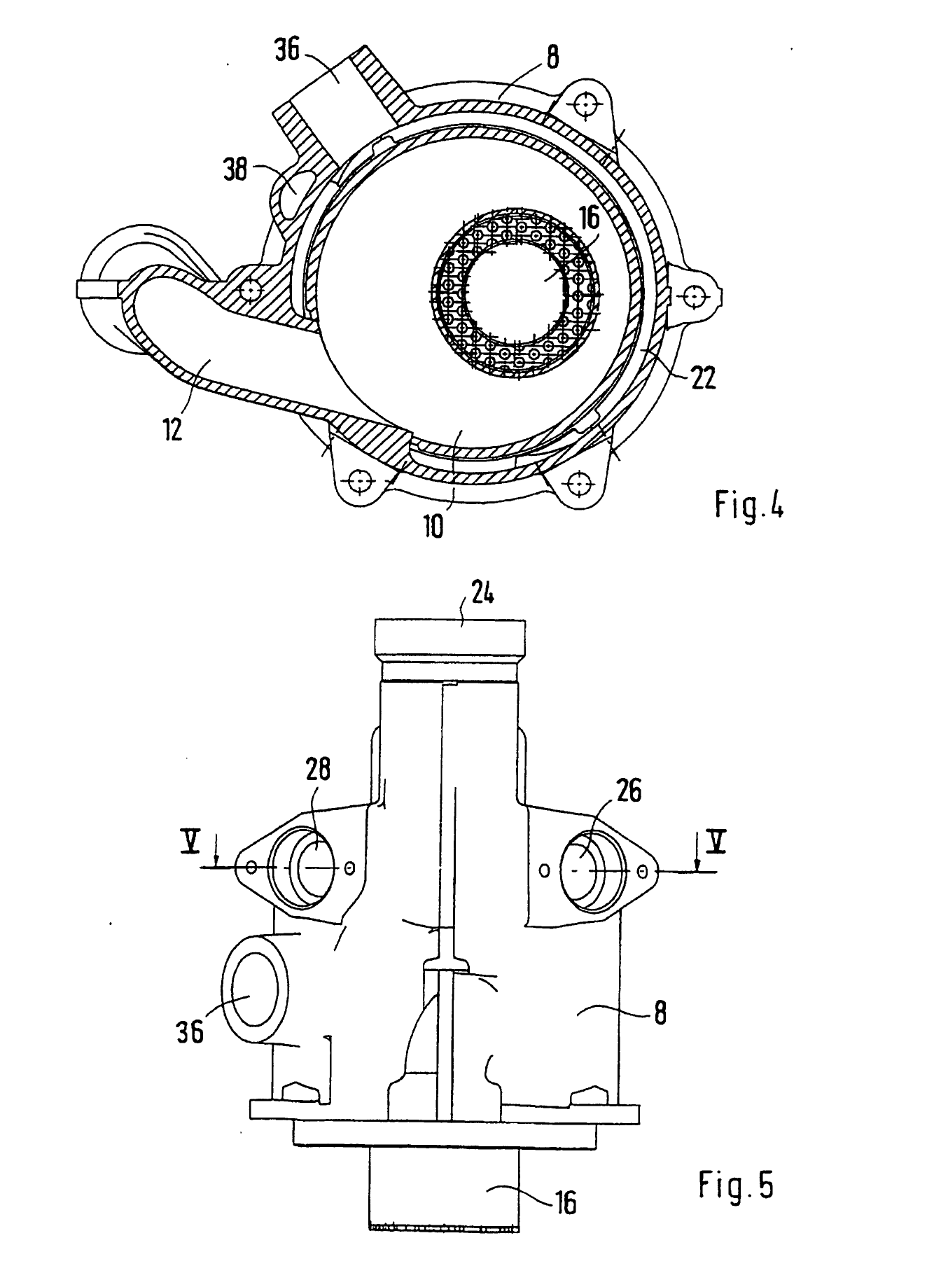

Referring to FIG. 3, a cyclone deaeration space 10 which is provided in the cylindrical housing 8 of the oil separator 6 is connected to the pressure side of a conventional oil suction pump (not shown) via a connection 12 provided in the housing 8, with the pump conveying the oil lubricant collected in the oil pan of the internal combustion engine into the oil tank 4. The cylindrical deaeration chamber 10 has a dome-shaped end section 14 which has a reduced diameter in comparison with the deaeration chamber 10. A deaeration pipe 16 is inserted, i.e., mounted at the end of the dome-shaped end section 14, its two end sections being provided with openings 18. A funnel-shaped, i.e., conical wire mesh body 20 is accommodated in the deaeration pipe 16 and inserted as a cartridge into the deaeration pipe 16.

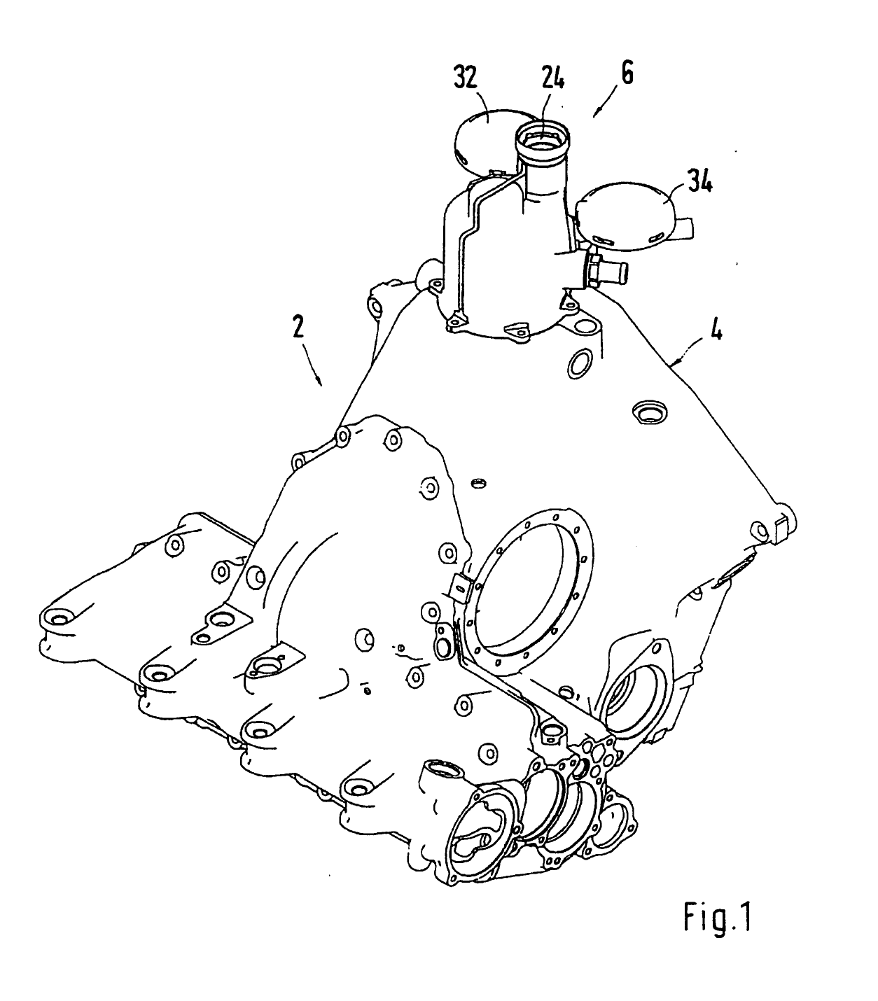

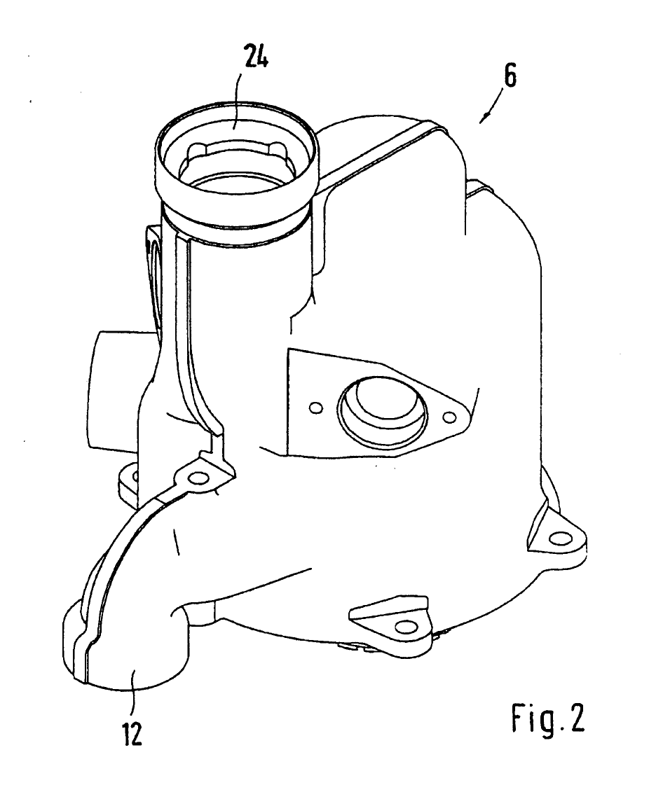

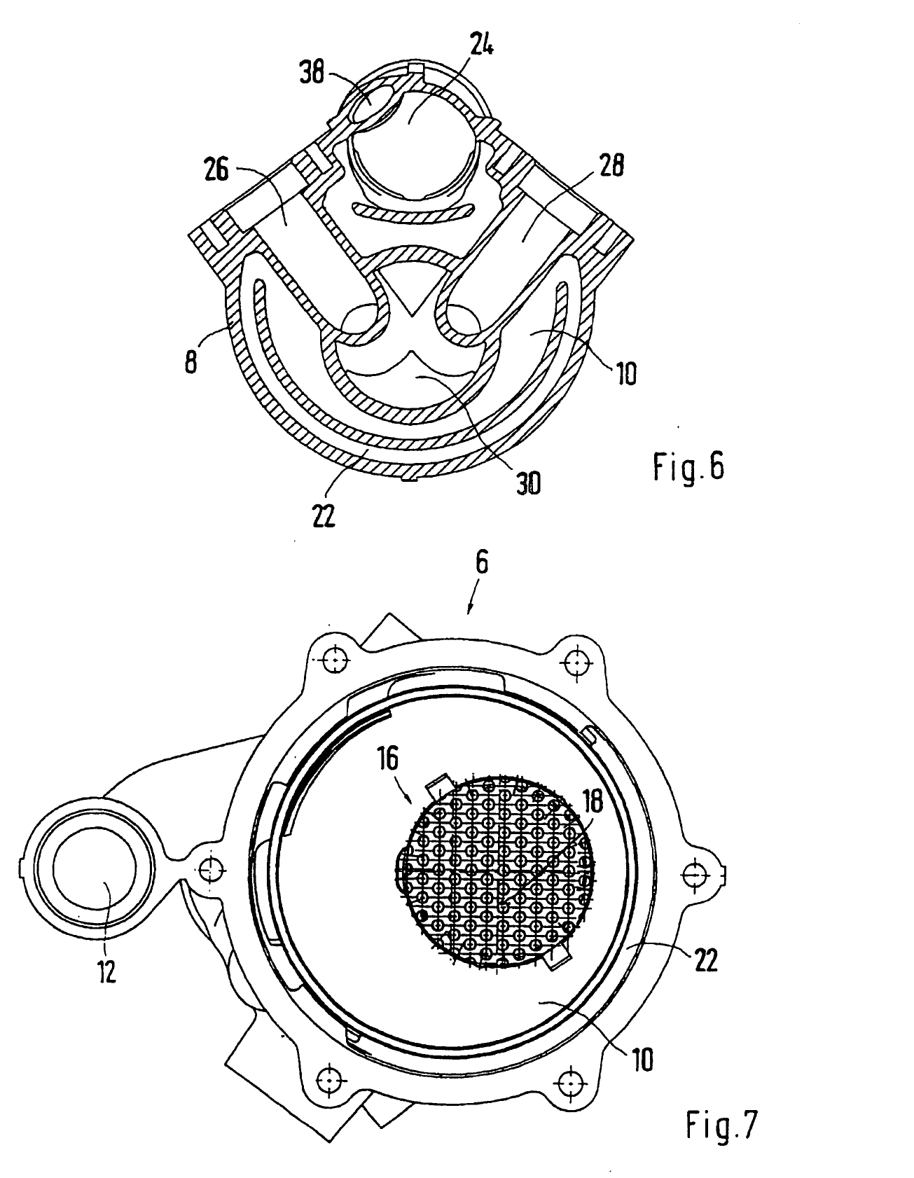

The housing 8 of the oil separator 6 has double walls in the area of the deaeration chamber 10 and a ring channel 22 which is coaxial with the deaeration chamber 10 and communicates at its upper end with an oil filling connection 24 and at its lower open end with the oil tank 4. As shown in FIGS. 5 and 6, the housing 8 has two connections 26, 28, both of which open into the chamber 30 which is formed above the deaeration pipe 16. A pressure-limiting valve 32, 34 (FIG. 1) is attached to each of two connections 26, 28, respectively and connected by corresponding lines (not shown) to the intake system of the internal combustion engine. A third connection 36, which is provided on the housing 8 of the oil separator 6, is connected first to the crankcase space and secondly to the ring channel 22 for deaeration of the crankcase. A channel 38, which is integrated into the housing 8, functions as a vent for filling the oil tank 4 with oil lubricant through the connection 24.

The functioning of the oil separator/refilling device is explained below in greater detail.

The oil lubricant conveyed through the connection 12 into the oil tank 4 enters tangentially into the deaeration space 10 which functions as a cyclone separator, with the oil flowing along the walls of the deaeration space 10 into the oil tank 4 due to centrifugal forces. The oil-laden gases can flow out through the deaeration pipe 16 by way of the openings 18 provided in the deaeration pipe 16 and therefore through the wire mesh body 20. The oil constituents are collected on the wire mesh and returned to the oil tank 4 while the gases from which the oil has been removed are sent back to the intake system of the internal combustion engine through the deaeration chamber 30. Since oil must be added at least at greater intervals for the oil lubricant supply for the internal combustion engine, this may be accomplished through the oil filling connection 24.

1. Device for defoaming and/or deaerating lubricant oil in the lubricant system of an internal combustion engine in which the lubricant oil flows back into an oil pan and is conveyable by an oil suction pump into a separate oil tank, comprising an oil separator wherein the oil separator has a deaeration space in which a wire mesh body is operatively accommodated.

2. Device as claimed in claim 1, wherein the wire mesh body is funnel shaped and with its narrower end pointing in the direction of the oil tank (4).

3. Device as claimed in claim 1, wherein the wire mesh body is accommodated in a deaeration pipe provided with openings at least on an end thereof

4. Device as claimed in claim 3, wherein an upper end of the deaeration pipe separates a partial deaeration space connected to a vacuum source.

5. Device as claimed in claim 1, wherein the deaeration space is surrounded by a ring channel connected to an oil filling connection.

6. Device as claimed in claim 5, wherein the ring channel has a connection for the crankcase deaeration.

7. Device as claimed in claim 1, wherein the oil tank is provided in the transmission case of the internal combustion engine.

8. Device as claimed in claim 1, wherein the oil separator is mounted on the oil tank.

9. Device as claimed in claim 3, wherein the wire mesh body is funnel shaped and with its narrower end pointing in the direction of the oil tank (4).

10. Device as claimed in claim 5, wherein the wire mesh body is funnel shaped and with its narrower end pointing in the direction of the oil tank (4).

11. Device as claimed in claim 10, wherein the wire mesh body is accommodated in a deaeration pipe provided with openings at least on an end thereof.

12. Device as claimed in claim 11, wherein an upper end of the deaeration pipe separates a partial deaeration space connected to a vacuum source.
